(19) United States
(12) Patent Application Publication
(10) Pub. No.: US 2023/0379646 A1
(43) Pub. Date: Nov. 23, 2023

(54) AUDIO PLAYBACK SYSTEM

(71) Applicant: Shih-Chieh HUANG, Hsinchu County (TW)

(72) Inventor: Shih-Chieh HUANG, Hsinchu County (TW)

(21) Appl. No.: 17/971,827

(22) Filed: Oct. 24, 2022

(30) Foreign Application Priority Data
May 17, 2022 (TW) 111118437

(51) Int. Cl. H04S 7/00; H04R 3/14; H04R 5/02; H04R 5/033; H04S 1/00; H04R 1/10; H04R 3/04; H04R 5/04

(52) U.S. Cl. CPC H04S 7/302; H04R 3/14; H04R 5/02; H04R 5/033; H04S 1/007; H04R 1/1008; H04R 3/04; H04R 5/04; H04S 2420/01

(57) ABSTRACT

An audio playback system includes a pair of front speakers, a wearable speaker, and a signal processor. The front speaker includes two independent speaker boxes and is configured to receive a front stereo signal. The wearable speaker includes two or more drivers, is adapted to allow a listener to listen to sounds in a peripheral environment, and is configured to receive a surround stereo signal. The signal processor is configured to receive a stereo signal; generate the surround stereo signal by processing the stereo signal with an attenuation function; adjust a delay time of the front stereo signal or the surround stereo signal so that a time difference between the sound waves emitted by the front speakers and the wearable speaker reaching the ears of the listener is less than a default value; output the front stereo signal and the surround stereo signal.

### CROSS-REFERENCE TO RELATED APPLICATION

This non-provisional application claims priority under 35 U.S.C. § 119(a) to Patent Application No. 111118437 filed in Taiwan, R.O.C. on May 17, 2022, the entire contents of which are hereby incorporated by reference.

### BACKGROUND

### Technical Field

The instant disclosure is related to an audio playback system, especially a stereo audio playback system.

### Related Art

Humans' spatial perception of sound is derived from interaural difference due to the differences between the sounds received by the two ears. The interaural difference can be divided into interaural time difference (ITD) and interaural level difference (ILD). The interaural time difference ITD and the interaural level difference ILD are also known as spatial cues of humans' auditory system and are provided for the brain to determine where the source of a sound is. Please refer to FIG. 1A and FIG. 1B. The interaural time difference ITD known to the inventor is defined as the time difference between a sound reaching the two ears from the source, while the interaural level difference ILD is defined as the received intensity difference between the two ears when listening to the same sound source. For example, when the source of a sound is approaching one of the two ears of a listener, the brain will be able to determine that the intensity perceived by the ear which the sound source is approaching is greater than the intensity perceived by the other ear. Therefore, the listener can determine the direction of the sound source and the distance between the sound source and the listener.

A stereo audio playback system is able to reproduce a sound field which is an imaginary three-dimensional space created by the high-fidelity reproduction of two speakers. For the stereo audio playback system, the placement of the speakers is directly related to the sound field perceived by a listener. It is understood that incorrect speaker placement can degrade sound field performance of playback systems. Please refer to FIG. 2A. FIG. 2A illustrates a schematic diagram of a listening distance (LD) known to the inventor. A ratio of the distance between the speakers (for example, in FIG. 2A, a television includes two built-in speakers on the left and right sides, and a distance is between the two speakers) to the LD is proportional to the size of the sound field. Specifically, for a fixed separation distance of left and right speakers, the longer the LD is, the smaller ILD and ITD are, so that the sound field perceived by the brain is reduced.

Please refer to FIG. 2B for a schematic diagram of an ideal speaker positioning known to the inventor. The separation distance between left and right speakers should not be too small, otherwise the perceived width of sound field would be narrower than it should be. The rule of thumb of speaker placement is to make the distance D1 between the two speakers approximately equal to the distance D2 between the listener and each of the speakers. In stereo audio recordings, ITD and ILD spatial cues are embedded in the left and right channel signals. As a result, the spatiality of the sound can be well reproduced if the stereo speakers are appropriately positioned. However, in modern cities, an inch of land in the busy section is worth an inch of gold, high cost must be paid for ideal speaker positioning.

### SUMMARY

In view of the above, according to one embodiment of the instant disclosure, the applicant provides an audio playback system comprising a pair of front speakers, a wearable speaker, and a signal processor. The pair of front speakers comprises two independent speaker boxes configured to receive a front stereo signal. The wearable speaker comprises at least two drivers. The wearable speaker has an open design that allows the wearer listening to ambient sound, and the wearable speaker is configured to receive a surround stereo signal. The signal processor is configured to receive a stereo signal; process the stereo signal according to an attenuation function so as to generate the surround stereo signal; perform a time delay adjustment on the front stereo signal or the surround stereo signal so that a difference between a time for a sound wave emitted by the front speakers to reach ears of the listener and a time for a sound wave emitted by the wearable speaker to reach the ears of the listener is less than a default value; output the front stereo signal to the front speakers; and output the surround stereo signal to the wearable speaker.

According to another embodiment of the instant disclosure, the applicant also provides an audio playback system comprising a front one-box speaker, a wearable speaker, and a signal processor. The front one-box speaker comprises at least two drivers configured to receive a front stereo signal. The wearable speaker comprises at least two drivers. The wearable speaker has an open design that allows the wearer listening to ambient sound, and the wearable speaker is configured to receive a surround stereo signal. The signal processor is configured to receive a stereo signal; process the stereo signal according to an attenuation function so as to generate the surround stereo signal; perform a time delay adjustment on the front stereo signal or the surround stereo signal so that a difference between a time for a sound wave emitted by the front speakers to reach ears of the listener and a time for a sound wave emitted by the wearable speaker to reach the ears of the listener is less than a default value; output the front stereo signal to the front speakers; and output the surround stereo signal to the wearable speaker.

### BRIEF DESCRIPTION OF THE DRAWINGS

The disclosure will become more fully understood from the detailed description given herein below for illustration only, and thus not limitative of the disclosure, wherein:

FIG. 1A illustrates a schematic diagram of the interaural time difference known to the inventor;

FIG. 1B illustrates a schematic diagram of the interaural level difference known to the inventor;

FIG. 2A illustrates a schematic diagram of a listening distance known to the inventor;

FIG. 2B illustrates a schematic diagram of speaker positioning for ideal sound field reproduction known to the inventor;

FIG. 3 illustrates a schematic diagram of an audio playback system according to some exemplary embodiments of the instant disclosure;

FIG. 4 illustrates a schematic diagram of the signal transmission relationship of the audio playback system according to some exemplary embodiments of the instant disclosure;

FIG. 5A illustrates a schematic diagram of a stereo-to-quadraphonic audio signal conversion process according to some exemplary embodiments (where the default overall delay time difference is greater than 0) of the instant disclosure;

FIG. 5B illustrates a schematic diagram of a stereo-to-quadraphonic audio signal conversion process according to some exemplary embodiments (where the default overall delay time difference is less than 0) of the instant disclosure;

FIG. 6A illustrates a schematic diagram of a crosstalk cancellation process of a surround stereo signal according to some exemplary embodiment of the instant disclosure;

FIG. 6B illustrates a schematic diagram of a recursive ambiophonic crosstalk eliminator;

FIG. 7 illustrates a schematic diagram of the crosstalk cancellation process of the front stereo signal and the surround stereo signal according to some exemplary embodiments of the instant disclosure;

FIG. 8 illustrates a schematic diagram of a head-related transfer function process of the surround stereo signal according to some exemplary embodiments of the instant disclosure; and

FIG. 9 illustrates a schematic diagram of the crosstalk cancellation process of the front stereo signal and the head-related transfer function process of the surround stereo signal according to some exemplary embodiments of the instant disclosure.

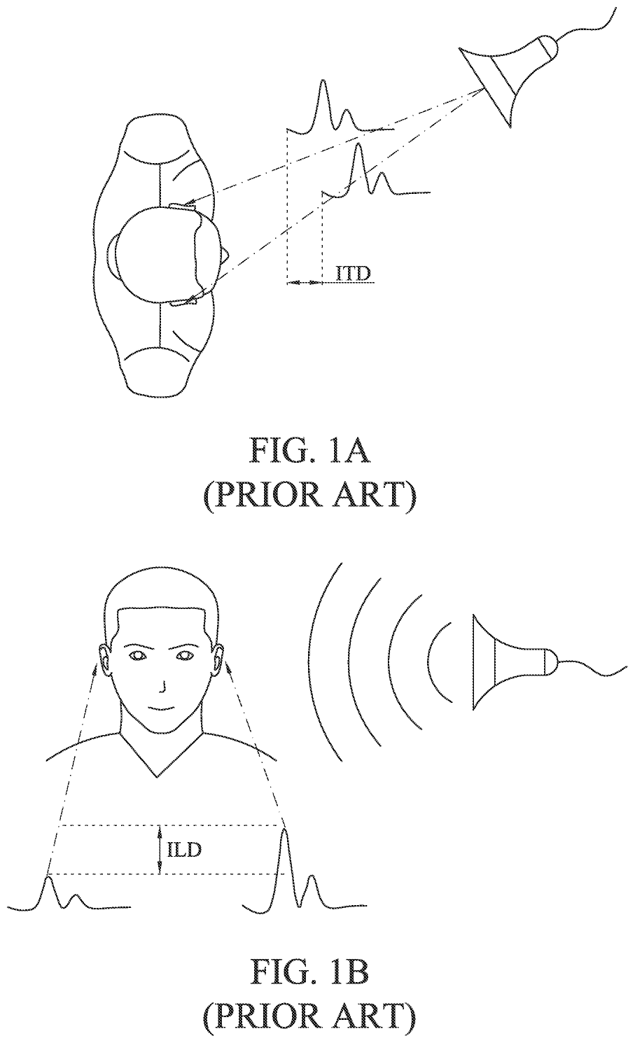

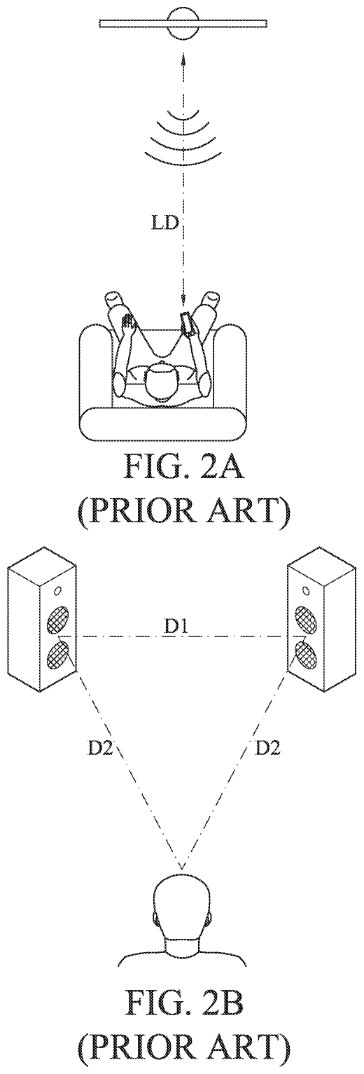

### DETAILED DESCRIPTION

A one-box speaker provides the advantage of small size, especially for environments with insufficient indoor space; however, smaller size implies the inability to reproduce sound field well. Take a soundbar as an example, the separation distance between the left and right speaker drivers is usually much less than the listening distance LD. As a result, severe crosstalk of the sound emitted by the built-in drivers will occur at the listening position. The crosstalk interference is caused owing that the left ear hears the sound emitted to the right by a driver and the right ear hears the sound emitted to the left by another driver. Therefore, the spatial cues of the interaural time difference ITD and the interaural level difference ILD included in the stereo signal substantially lose their effectiveness. As a result, the sound field becomes much smaller than how it is originally intended. Although crosstalk cancellation techniques can effectively reduce the crosstalk problem for a soundbar, the reproduced sound field is limited to the front space, and the feeling of surround and immersive sound field will not be achieved.

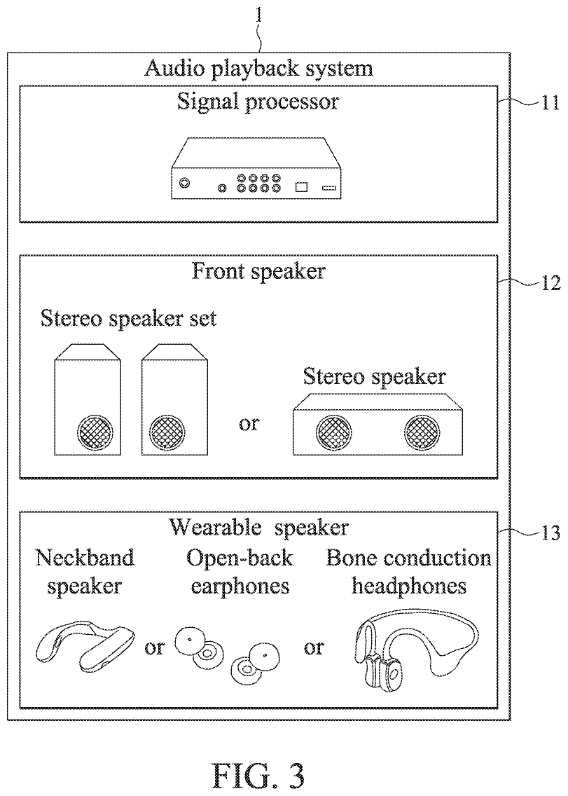

Please refer to FIG. 3. FIG. 3 illustrates a schematic diagram of an audio playback system according to some exemplary embodiments of the instant disclosure. According to some embodiments of the instant disclosure, the audio playback system 1 comprises a signal processor 11, a front speaker 12, and a wearable speaker 13. The signal processor 11 may be implemented using a system on a chip (SoC), a central processing unit (CPU), a micro-control unit (MCU), an application specific integrated circuit (ASIC), a field programmable gate array (FPGA), a logic circuit, or the like. For example, the signal processor 11 may be the processing chip of a personal computer, a mobile phone, a tablet computer, or a laptop computer. Besides, the signal processor 11 is not limited to an integrated chip or circuit and may also be the aggregation of a plurality of chips and/or circuits. For example, the signal processor 11 may comprise the processing chip of a mobile phone and the processing chip of a pair of earphones, wherein the two chips perform different steps of signal processing.

The front speaker 12 may be a stereo speaker set (separate stereo speakers) comprising two speakers, wherein each of the speakers are allowed to be placed at an appropriate location to produce a preferable sound field. Alternatively, in some other embodiments, the front speaker 12 may be a one-box stereo speaker integrated with a plurality of drivers, such as a soundbar. However, in some exemplary embodiments, for the soundbar configuration, additional audio signal processing is applied to reduce crosstalk problems (will be illustrated later). In some exemplary embodiments, the front speaker 12 may also be integrated into other electronic devices. For example, the front speaker 12 may be the built-in stereo speakers of a display device.

The wearable speaker 13 may be a neckband speaker designed to be worn on a neck portion of a listener and emit sound waves directed toward the wearer's left and right ears. The neckband speaker may comprise two or more built-in drivers with one or more drivers at each side near the left ear and the right ear respectively. Alternatively, in some embodiments, the neckband speaker may be a pair of bone conduction headphones designed to generate vibrations that are conducted to the auditory ossicles. Or, in some embodiments, the wearable speaker 13 may also be a pair of open-back earphones designed to emit stereo sound waves and allows the listener to hear the environmental sounds.

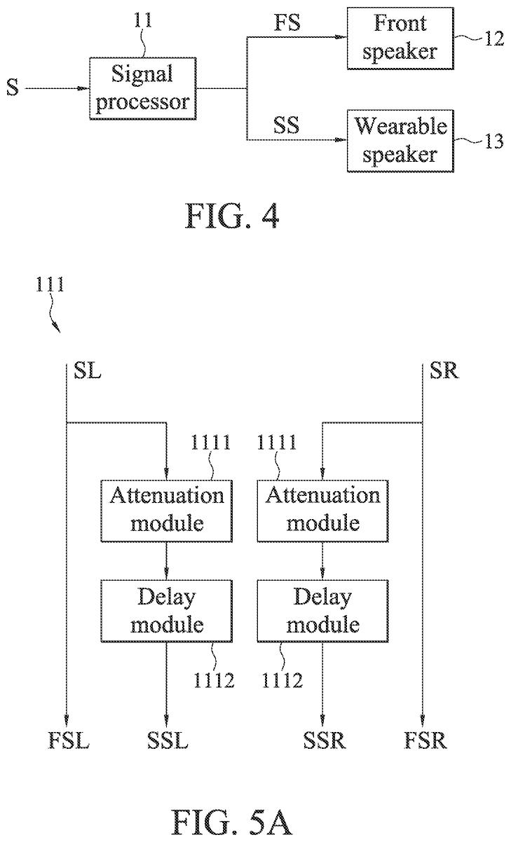

Please refer to FIG. 4. FIG. 4 illustrates a schematic diagram of the signal flow of the audio playback system according to some exemplary embodiments of the instant disclosure. The signal processor 11 is configured to receive a stereo signal S so as to generate a front stereo signal FS to the front speaker 12 and generate a surround stereo signal SS to the wearable speaker 13. The front speaker 12 is connected to the signal processor 11, and the wearable speaker 13 is also connected to the signal processor 11, wherein the connection is not limited to wired or wireless connection. In other words, in this embodiment, the front stereo signal FS and the surround stereo signal SS may each be a wired signal or a wireless signal. The wireless signal may adopt communication protocols such as, but not limited to, wireless fidelity (Wi-Fi), ZigBee, Bluetooth, or proprietary radio frequency (RF).

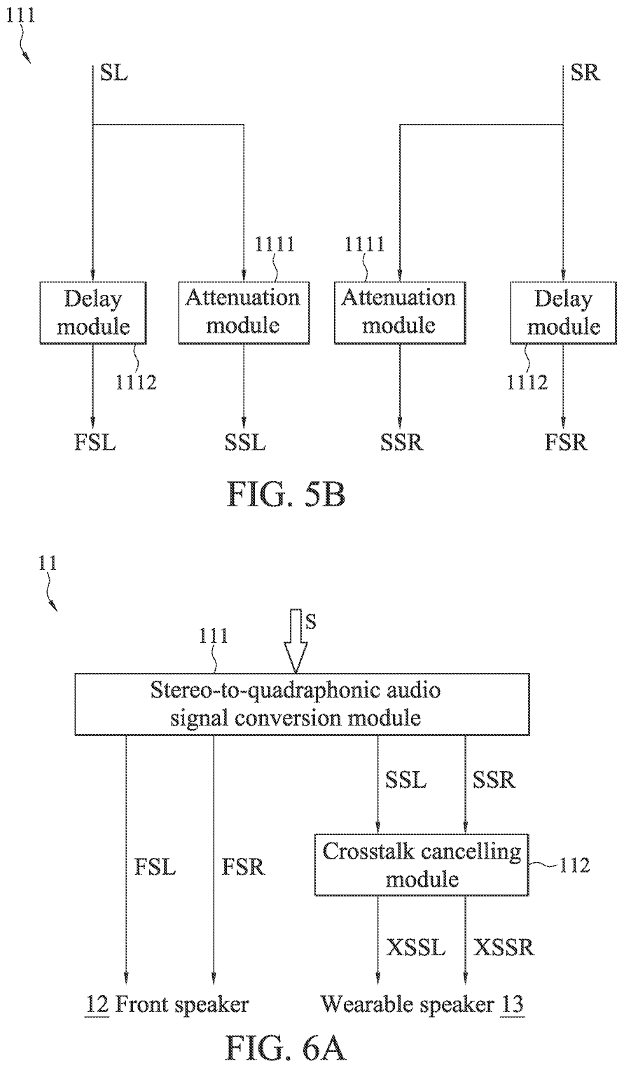

The front speaker 12 and the wearable speaker 13 emit sound waves simultaneously to deliver an immersive sound filed experience. The reason for adding the wearable speaker 13 to the audio playback system 1 is to add ambient reflection sounds. The ambient reflection sounds have properties including the intensity attenuation and the transmission time delay compared with a direct sound emitted by the front speaker 12. The intensity attenuation is controlled through an attenuation function. The compensation for the transmission time delay is performed in the time-domain based on the overall delay time difference between the generation of electrical signals, the transmission of electrical signals to the front speaker 12 and the wearable speaker 13, and the sound waves emitted from the two speakers to reach the ears of the listener respectively. This compensation is to make sure the two sound waves emitted by the front speaker 12 and the wearable speaker 13 reach the listener's ears at approximately the same time. Therefore, the listener won't have the feeling of sound field incoordination. Please refer to FIG. 5A. FIG. 5A illustrates a schematic diagram of a stereo-to-quadraphonic audio signal conversion process according to some exemplary embodiments (where the default overall delay time difference is greater than 0) of the instant disclosure. The signal processor 11 is configured to convert the stereo signal S into a quadraphonic signal. In this exemplary embodiment, the signal processor 11 comprises a stereo-to-quadraphonic audio signal conversion module 111. The front speaker 12 and the wearable speaker 13 are both stereophonic, and thus there are four audio channels in total. The stereo signal S comprises a left stereo signal SL and a right stereo signal SR. In some exemplary embodiments, the signal processor 11 respectively processes the left stereo signal SL and the right stereo signal SR according to the following four equations so as to generate a left surround stereo signal SSL and a right surround stereo signal SSR.

SL′=A(SL) (Equation 1)

SR′=A(SR) (Equation 2)

SSL=SL′(n−TD) (Equation 3)

SSR=SR′(n−TD) (Equation 4)

wherein A( ) denotes an attenuation function and may be a linear function with one variable and a coefficient being in a range between 0 and 1: A(x)=kx, where k is a constant; alternatively, in some embodiments, A( ) may also be an attenuation function with ambient reflection coefficient and listening distance LD as input variables; SL and SR denote digitally sampled left stereo signal and right stereo signal, respectively; n denotes discrete sampling instant of the stereo signal S (i.e., the left stereo signal SL and the right stereo signal SR); and TD denotes default overall delay time difference. The attenuation function A( ) is configured to simulate the amount of intensity attenuation with the listening distance LD. In some exemplary embodiments, the listening distance LD has a default value assigned when the signal processor 11 is manufactured. In some other exemplary embodiments, the listening distance LD is an user-adjustable variable. In some exemplary embodiments, the attenuation function A( ) may be implemented using a digital filter with filter gain is less than 1, so that not only the signal intensity attenuation can be achieved, but also the-timbre can be modified through different digital filter response.

The default overall delay time difference includes two parts: the first part is a system-wise electrical signal transmission time difference (STD) between two different signal transmission paths, which are the paths from the signal processor 11 to the front speaker 12 and from the signal processor 11 to the wearable speaker 13; the second part is an air propagation time difference between the time for the sound emitted by the front speaker 12 to reach the ears of the listener and the time for the sound emitted by the wearable speaker 13 to reach the ears of the listener. The default overall delay time difference is obtained by summing up the air propagation time difference and the system-wise electrical signal transmission time delay. The processor performs time-domain inverse compensation on the stereo signal S and the surround stereo signal SS according to the default overall delay time difference, so that the time difference between the time at which the sound emitted by the wearable speaker 13 reaches the listener and the time at which the sound emitted by the front speaker 12 reaches the listener is less than a default tolerable value. Therefore, when the front speaker 12 and the wearable speaker 13 emit sounds at the same time, the listener can be prevented from having the feeling of incoordination. The tolerable value may be adjusted by the user within a limited range. Through experimentation, it is found that, when the tolerable value is within a range less than 80 milliseconds (ms), the front sound field established by the front speaker 12 and the surround sound field established by the wearable speaker 13 can be combined into a whole, and thus an immersive sound field can be achieved. When the overall delay time difference is less than 5 ms, focusing of the sound image within the sound field is optimal. When the overall delay time difference gradually increases within the range between 5 ms and 80 ms, spatial reverberation effect of the sound field increases, and the focusing of the sound image is slightly fuzzier but is still perceived as one. When the overall delay time difference increases over 80 ms, the onset time difference between the two sound fields will become more noticeable, where separation of the sound fields can further happen. However, the aforementioned separation of the sound fields is not tolerated by the exemplary embodiments of the instant disclosure, and thus the tolerable range of value of the overall delay time difference is within 80 ms.

The air propagation time difference can be calculated using Equation 5. The signal transmission time difference is dependent on system configuration and is obtained through measurement. In some exemplary embodiments, when the signal processor 11 is connected to the front speaker 12 and the wearable speaker 13 through respective wireless signals, and the two wireless signals are transmitted under the same transmission mechanism, the signal transmission time difference between the two wireless signals can almost be ignored, and merely the air propagation time difference is to be taken into consideration. In this case, the default overall delay time difference TD can be obtained using Equation 5 below:

TD=INT(fs*LD/v) (Equation 5)

In Equation 5, INTO denotes a units integer floor and ceiling function such as an unconditional carry function, an unconditional round function, or a round function; fs denotes the sampling rate of the stereo signal S by the signal processor 11; and v denotes a the default value of speed of sound, which equals 346 m/s under the condition of room temperature (25° C.). The default value of speed of sound v is a function with ambient temperature T (in Celsius) as an input parameter: v=331+0.6 T.

However, when the signal processor 11 is built-in the front speaker 12 or directly wired to the front speaker 12, and the signal processor 11 is wirelessly connected to the wearable speaker 13, the signal transmission time difference has to be taken into consideration. As a result, in some other exemplary embodiments, in the case that both the air propagation time difference and electrical signal transmission time difference are taken into consideration, the default overall delay time difference TD can be calculated using Equation 6 below:

TD=INT(fs*LD/v)+STD (Equation 6)

In Equation 6, STD denotes the system-wise electrical signal transmission time difference (system-wise delay time). The first electrical signal transmission time denotes the time it takes to transmit signal from the signal processor 11 to the front speaker 12, and the second electrical signal transmission time denotes the time it takes to transmit signal from the signal processor 11 to the wearable speaker 13, the system-wise electrical signal transmission time difference STD is the difference between the first electrical signal transmission time and the second electrical signal transmission time. The system-wise delay time is obtained through measurement and is not relevant to the listening distance LD, and thus the system-wise delay time is a default fixed value. When the first electrical signal transmission time is less than the second electrical signal transmission time and the difference between the first electrical signal transmission time and the second electrical signal transmission time is negative, the calculated value of TD using Equation 6 (TD=INT(fs*LD/v)+STD) may lead to a negative result. Negative TD implies that the second electrical signal transmission time between the signal processor 11 and the wearable speaker 13 is greater than the first electrical signal transmission time between the signal processor 11 and the front speaker 12, and that the difference between the first electrical signal transmission time and the second electrical signal transmission time is greater than the air propagation delay time difference between the front speaker 12 and the wearable speaker 13. Under this condition, the time delay compensation should be performed on the left stereo signal SL and the right stereo signal SR of the front speaker 12, while merely the attenuation process is performed on the left surround stereo signal SSL and the right surround stereo signal SSR. This processes can be described as Equation 7 through Equation 10 below:

SLD=SL(n−TD) (Equation 7)

SRD=SR(n−TD) (Equation 8)

SSL=A(SL(n)) (Equation 9)

SSR=A(SR(n)) (Equation 10)

wherein SLD denotes the left stereo signal SL after time compensation, and SRD denotes the right stereo signal SR after time compensation.

Please refer to FIG. 5A. The following illustration takes the left stereo signal SL as an example. The left stereo signal SL is duplicated to form a first signal and a second signal. In some exemplary embodiments, when the default overall delay time difference is greater than 0, the first signal serves as a left front stereo signal FSL and is outputted to the front speaker 12. On the other hand, the second signal is processed by an attenuation module 1111 and a delay module 1112 of the signal processor 11, attenuated using the attenuation function A( ) and delayed by the default overall delay time difference TD, and then serves as a left surround stereo signal SSL and is outputted to the wearable speaker 13. In some exemplary embodiments, the attenuation function A( ) is the ratio of an amplification factor of the second signal to the amplification factor of the first signal. In other words, in this embodiment, even when the amplification factor of the second signal is 1 and the amplification factor of the first signal is greater than 1, such a case can also be considered as an attenuation process performed on the second signal. In this exemplary embodiment, when the front speaker 12 plays the left front stereo signal FSL, the emitted sound wave reaching the listener is attenuated through the listening distance LD and delayed through air propagation; on the other hand, when the wearable speaker 13 plays the left surround stereo signal SSL, the sound wave is emitted after the default overall delay time difference. Therefore, the two sound waves reach the listener at the same time to form the immersive sound field effect together. It should be understood that FIG. 5A illustrates only one exemplary embodiment of the processes performed on the stereo signal S, and the processing order of the stereo signal S by the attenuation module 1111 and the delay module 1112, is not limited thereto.

Please refer to FIG. 5B. FIG. 5B illustrates a schematic diagram of a stereo-to-quadraphonic audio signal conversion process according to some exemplary embodiments (where the default overall delay time difference is less than 0) of the instant disclosure. In some exemplary embodiments, the default overall delay time difference is less than 0. The following illustration takes the left stereo signal SL as an example. The left stereo signal SL is duplicated to form a first signal and a second signal. The first signal is delayed by the default overall delay time difference TD, serves as the left front stereo signal FSL, and is outputted to the front speaker 12. On the other hand, the second signal is processed by the attenuation module 1111 of the signal processor 11, attenuated using the attenuation function A( ), and then serves as the left surround stereo signal SSL and is outputted to the wearable speaker 13. In this exemplary embodiment, when the front speaker 12 plays the left front stereo signal FSL which is delayed by the default overall delay time difference TD, the sound wave reaches the listener's ear after the air propagation time; on the other hand, the wearable speaker 13 also plays the left surround stereo signal SSL without delay time compensation. Therefore, the two sound waves reach the listener's ear at the same time to form the immersive sound field effect together. This exemplary embodiment is suitable for systems in which the signal processor 11 is wire-connected to the front speaker 12 and wirelessly connected to the wearable speaker 13. In some embodiments, since the delay time of wireless transmission is usually far longer than that of wired transmission, and the time difference between wireless transmission and wired transmission is greater than the air propagation delay, the left front stereo signal SFL should be added with a time delay. Therefore, the left front stereo signal SFL with the time delay and the surround stereo signal through wireless transmission can reach the ears of the listener at the same time.

The foregoing exemplary embodiments shown in FIG. 5A and FIG. 5B both include performing a default overall delay compensation on the front stereo signal FS or the surround stereo signal SS. Therefore, the front speaker 12 plays the front stereo signal FS, the sound wave reaches the listener's ears after the air propagation time and the sound wave (the surround stereo signal SS) emitted by the wearable speaker 13 reaches the listener's ears at the same time. However, some exemplary embodiments allow the user to adjust the value of the default overall delay compensation within a range of less than 80 ms, so that the surround stereo sound waves emitted by the wearable speaker 13 will reach the listener's ears slightly later than the front stereo sound waves emitted by the front speaker 12 and thus an effect similar to the spatial reverberation effect can be provided.

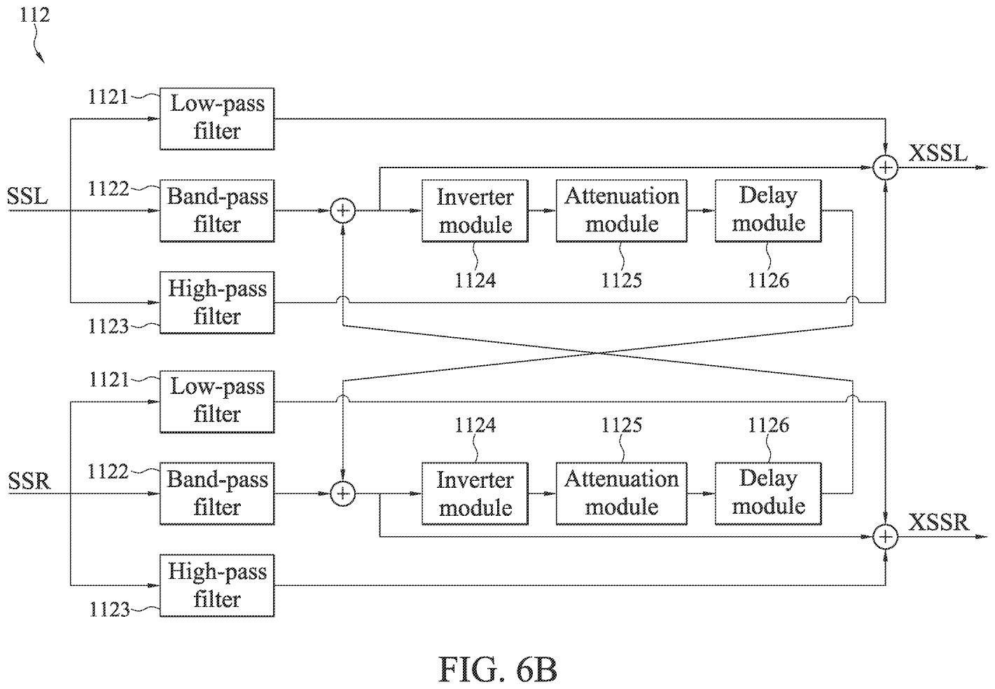

In some exemplary embodiments, the wearable speaker 13 may be a neckband speaker. As previously illustrated, when the left (right) ear hears the sound emitted towards the right (left) ear, crosstalk interference occurs, and thus the sound field performance is degraded. This situation may also occur when using the neckband speaker. Please refer to FIG. 6A. FIG. 6A illustrates a schematic diagram of a crosstalk cancellation process of a surround stereo signal according to some exemplary embodiment of the instant disclosure. In some exemplary embodiments, the signal processor 11 comprises a stereo-to-quadraphonic audio signal conversion module 111 and a crosstalk cancelling module 112. After the stereo signal S is processed by the stereo-to-quadraphonic audio signal conversion module 111, a front stereo signal FS (i.e., FSL and FSR shown in FIG. 6A) and a surround stereo signal SS (i.e., SSL and SSR in FIG. 6A) are generated. In some exemplary embodiments, before being outputted, the surround stereo signal SS is processed using crosstalk cancellation algorithm, so that crosstalk-cancelled surround stereo signals XSSL, XSSR are obtained. The crosstalk cancellation algorithm can be implemented using a variety of methods. The following exemplary embodiment adopts a simpler recursive ambiophonic crosstalk eliminator (RACE) algorithm for illustration. Please refer to FIG. 6B and Equation 11 and Equation 12 below. FIG. 6B illustrates a schematic diagram of a recursive ambiophonic crosstalk eliminator.

XSSL=SSL(n)−AL′*SSR(n−DT′) (Equation 11)

XSSR=SSR(n)−AR′*SSL(n−DT′) (Equation 12)

In Equation 11 and Equation 12, XSSL and XSSR denote the crosstalk-cancelled surround stereo signals (left (L) and right (R)); SSL and SSR denote digitally sampled signals of the surround stereo signals (left (L) and right (R)); AL′ and AR′ denote attenuation factors in a range between −2 dB and −4 dB; n denotes the sampling instant of the surround stereo signal SS (i.e., the left surround stereo signal SSL and the right surround stereo signal SSR); DT′ denotes a default crosstalk delay time, which represents the air propagation time difference for a sound wave emitted by one of the left speaker and the right speaker to reach the two ears of the listener, respectively (roughly 60-120 μs). Take the left surround stereo signal SSL and the right surround stereo signal SSR as example, the left surround stereo signal SSL, after being inputted into the RACE crosstalk cancellation module, is bandpass filtered by a bandpass filter 1122, phase inverted by an inverter module 1124, attenuated by an attenuation module 1125, and delayed by a delay module 1126. During this process, high-frequency band and low-frequency band (outputs of a highpass filter 1123 and a lowpass filter 1121) are bypassed, only mid-frequency band needs crosstalk cancellation. The recommended crossover frequency between highpass and bandpass filters is 5000 Hz, and the recommended crossover frequency between lowpass and bandpass filters is 250 Hz. Sound waves lower than 250 Hz cause a very small phase difference between the two ears, and this phase difference is not helpful for spatiality determination. In the embodiment shown in FIG. 6B, the attenuation factors AL′, AR′ and the crosstalk delay time DT′ are related to an angle between two lines respectively formed by connecting the two ears to the speaker on one side, and are also related to the distance between the two ears (Inter-aural distance, IAD): the greater the angle and IAD is, the less smaller the attenuation factors is, and the longer IAD, the longer the crosstalk delay time is; After being processed by the RACE algorithm, the anti-crosstalk signal of the other channel that causes interference is already added to the mid-frequency of the processed channel before outputting to speakers, and thus the crosstalk interference has been suppressed. It should be noted that, since the vibrations generated at the right (left) ear by the bone conduction headphones can be transmitted to the left (right) ear through the skull, the crosstalk cancellation performed on the surround stereo signal SS is also suitable for the exemplary embodiments adopting bone conduction headphones.

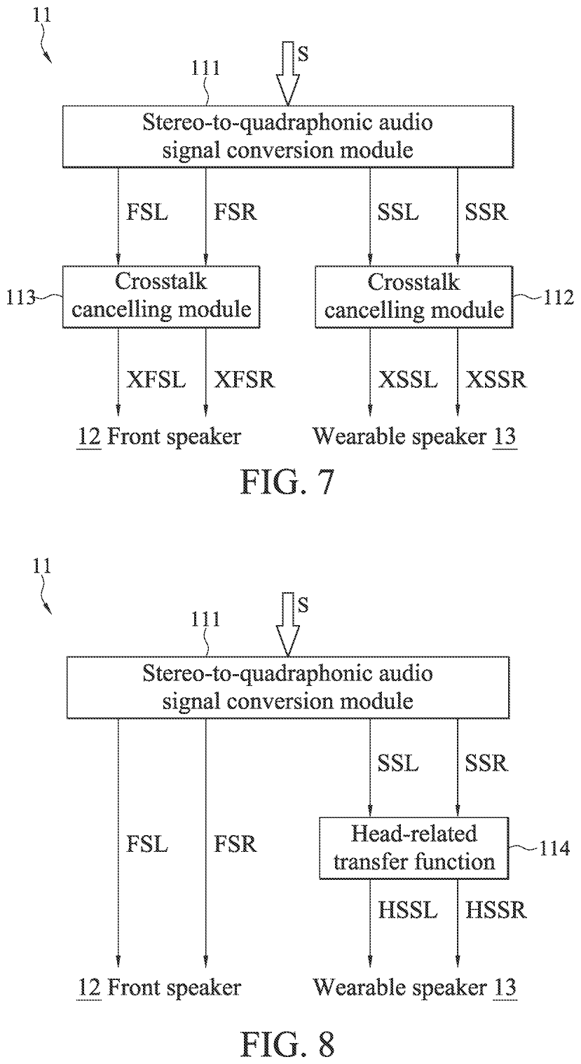

Please refer to FIG. 7. FIG. 7 illustrates a schematic diagram of the crosstalk cancellation process of the front stereo signal and the surround stereo signal according to some exemplary embodiments of the instant disclosure. For a one-box stereo speaker, the crosstalk interference is an unavoidable problem. In view of this, in some exemplary embodiments, the signal processor 11 comprises a stereo-to-quadraphonic audio signal conversion module 111, a crosstalk cancelling module 112, and a crosstalk cancelling module 113. Before being outputted, the left front stereo signal FSL and the right front stereo signal FSR are processed with crosstalk cancellation by the crosstalk cancelling module 113, so that crosstalk-cancelled front stereo signals XFSL, XFSR are obtained. For example, the front speaker 12 may be the built-in stereo speakers of a display device, the signal processor 11 may be implemented using the processing chip of the display device, and the wearable speaker 13 may be a neckband speaker. In this situation, respective processing for the front stereo signal FS and the surround stereo signal SS with crosstalk cancellation can yield good sound field experience.

In some exemplary embodiments, the wearable speaker 13 may be a pair of open-back earphones. Although the open-back earphones allow the listener to hear ambient sounds, the sound emitted by one side of the earphones is hardly heard by the listener's opposite ear, and thus the crosstalk problem is less serious. However, using head-related transfer functions (HRTFs) to process the audio signals played by the open-back earphones will allow the audio signal to contain spatial cues such as the interaural time difference ITD and the interaural level difference ILD, so that sounds with spatiality can be emulated. The HRTF process is similar to a filtering process, in the sense that the HRTF process attenuates sounds from different directions with different extents, so that the shielding effect caused by human head and torso of sound waves in real situations can be emulated.

The HRTF process requires definition of positional angle of the sound source. The positional angle includes azimuth θ and elevation φ. The positional angle is used to determine a head-related impulse response (HRIR) coefficients corresponding to the two ears in an HRTF database (such as CIPIC, MIT, and RIEC) for the filtering process. For some exemplary embodiments of the instant disclosure, when the wearable speaker 13 of the audio playback system 1 adopts the open-back earphones, it is desired that the source of surround sound comes from behind the listener. Under this configuration letting the direction to the front the listener be 0 degree reference, the recommended azimuth is in the range between 120 and 150 degrees, and the recommended elevation is in the range of −5 and 5 degrees.

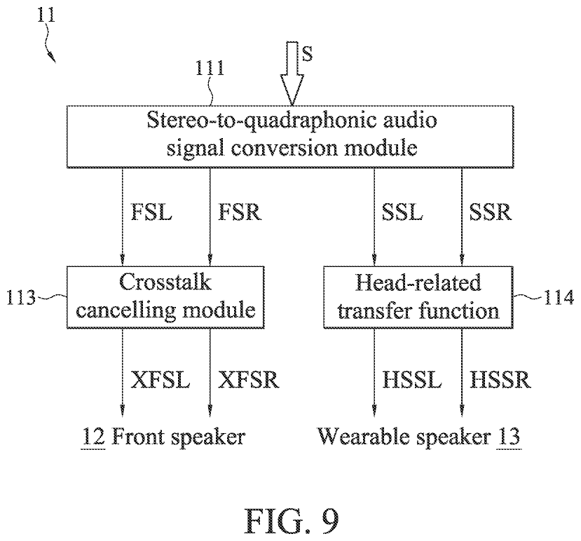

Please refer to FIG. 8. FIG. 8 illustrates a schematic diagram of a head-related transfer function process of the surround stereo signal according to some exemplary embodiments of the instant disclosure. In some exemplary embodiments, for a separate front speaker set, appropriate speaker placement can reduce the influence of crosstalk problem, and thus the front stereo signal FS may not be processed with the crosstalk cancellation process. In this exemplary embodiment, the signal processor 11 comprises a stereo-to-quadraphonic audio signal conversion module 111 and a head-related transfer function 114. The stereo-to-quadraphonic audio signal conversion module 111 processes the stereo signal S to generate a front stereo signal FS (i.e., FSL and FSR shown in FIG. 8) and a surround stereo signal SS (i.e., SSL and SSR shown in FIG. 8). Before being outputted, the surround stereo signal SS is processed with the HRTF process, so that HRTF-processed surround stereo signals HSSL, HSSR are obtained. Please refer to FIG. 9. FIG. 9 illustrates a schematic diagram of the crosstalk cancellation process of the front stereo signal and the head-related transfer function process of the surround stereo signal according to some exemplary embodiments of the instant disclosure. In some other exemplary embodiments, when the audio playback system 1 adopts the open-back earphones and the front soundbar, it is recommended to perform crosstalk cancellation on the front stereo signal FS and perform the HRTF process on the surround stereo signal SS.

In some exemplary embodiments, the audio playback system 1 may comprise a plurality of wearable speakers 13, and the signal processor 11 transmits identical surround stereo signals to each of the wearable speakers 13.

In some exemplary embodiments, the stereo-to-quadraphonic audio signal conversion module 111, the crosstalk cancelling module 112, and the crosstalk cancelling module 113 (or head-related transfer function 114) of the signal processor 11 may be integrated in the internal processing chip of a mobile phone, and then the signals are transmitted to the front speaker 12 and the wearable speaker 13. However, in some other exemplary embodiments, the stereo-to-quadraphonic audio signal conversion module 111 may be implemented in an independent processing chip, the crosstalk cancelling module 113 may be implemented in a processing chip of the front speaker 12, and the crosstalk cancelling module 112 or the head-related transfer function 114 may be implemented in a processing chip of the wearable speaker 13.

The features such as ratio relationships, structures, and sizes presented in the instant disclosure are only intended for illustration of the exemplary embodiments, so that persons skilled in the art can properly comprehend the instant disclosure, and thus are not intended to limit the scope of claims of the instant disclosure. The foregoing illustration outlines features of several embodiments so that those skilled in the art may better understand the aspects of the instant disclosure. Those skilled in the art should appreciate that they may readily use the instant disclosure as a basis for designing or modifying other processes and structures for carrying out the same purposes and/or achieving the same advantages of the embodiments introduced herein. Those skilled in the art should also realize that such equivalent constructions do not depart from the spirit and scope of the instant disclosure, and that they may make various changes, substitutions, and alterations herein without departing from the spirit and scope of the instant disclosure.

What is claimed is:

1. An audio playback system comprising:
a pair of front speakers comprising two independent speaker boxes configured to receive a front stereo signal;
a wearable speaker comprising at least two drivers, wherein the wearable speaker is designed to allow a listener to hear the environmental sounds, and the wearable speaker is configured to receive a surround stereo signal; and
a signal processor configured to:
receive a stereo signal;
process the stereo signal according to an attenuation function so as to generate the surround stereo signal;
perform time delay adjustment on the front stereo signal or the surround stereo signal so that a difference between a time for a soundwave emitted by the front speakers to reach ears of the listener and a time for a soundwave emitted by the wearable speaker to reach the ears of the listener is less than a default value; and
output the front stereo signal to the front speakers and output the surround stereo signal to the wearable speaker.

2. The audio playback system according to claim 1, wherein the default value is equal to or less than 80 milliseconds (ms).

3. The audio playback system according to claim 1, wherein the wearable speaker is a neckband speaker or a pair of bone conduction headphones.

4. The audio playback system according to claim 3, wherein the signal processor further comprises a first crosstalk cancelling module, and the first crosstalk cancelling module performs crosstalk cancellation on a left audio channel of the surround stereo signal and a right audio channel of the surround stereo signal and then outputs a crosstalk cancelled surround stereo signal as the surround stereo signal.

5. The audio playback system according to claim 1, wherein the wearable speaker is a pair of open-back earphones.

6. The audio playback system according to claim 5, wherein the signal processor further comprises a head-related transfer function, and the signal processor processes the left audio channel of the surround stereo signal and the right audio channel of the surround stereo signal based on the head-related transfer function and then outputs the surround stereo signal.

7. An audio playback system comprising:
a front one-box speaker comprising at least two speaker drivers configured to receive a front stereo signal;
a wearable speaker comprising at least two drivers, wherein the wearable speaker is designed to allow a listener to hear the environmental sounds, and the wearable speaker is configured to receive a surround stereo signal; and
a signal processor configured to:
receive a stereo signal;
process the stereo signal according to an attenuation function so as to generate the surround stereo signal;
perform time delay adjustment on the front stereo signal or the surround stereo signal so that a difference between a time for a soundwave emitted by the front one-box speaker to reach ears of the listener and the time for a soundwave emitted by the wearable speaker to reach the ears of the listener is less than a default value; and
output the front stereo signal to the front one-box speaker and output the surround stereo signal to the wearable speaker.

8. The audio playback system according to claim 7, wherein the default value is equal to or less than 80 milliseconds (ms).

9. The audio playback system according to claim 7, wherein the signal processor further comprises a second crosstalk cancelling module, and the second crosstalk cancelling module performs crosstalk cancellation on a left audio channel of the front stereo signal and a right audio channel of the front stereo signal and then outputs a crosstalk cancelled front stereo signal as the front stereo signal.

10. The audio playback system according to claim 9, wherein the wearable speaker is a neckband speaker or a pair of bone conduction headphones.

11. The audio playback system according to claim 10, wherein the signal processor further comprises a first crosstalk cancelling module, and the first crosstalk cancelling module performs crosstalk cancellation on a left audio channel of the surround stereo signal and a right audio channel of the surround stereo signal and then outputs a crosstalk cancelled surround stereo signal as the surround stereo signal.

12. The audio playback system according to claim 11, wherein the signal processor and the front one-box speaker are integrally configured with each other.

13. The audio playback system according to claim 11, wherein the signal processor and the front one-box speaker are integrally configured into a display device.

14. The audio playback system according to claim 9, wherein the wearable speaker is a pair of open-back earphones.

15. The audio playback system according to claim 14, wherein the signal processor further comprises a head-related transfer function, and the signal processor processes the left audio channel of the surround stereo signal and the right audio channel of the surround stereo signal based on the head-related transfer function and then outputs the surround stereo signal.

16. The audio playback system according to claim 7, wherein the signal processor further comprises a filter with filter gain less than 1, the frequency response of the filter serves as the attenuation function.
